(19) United States
(12) Patent Application Publication
(10) Pub. No.: US 2019/0333093 A1
(43) Pub. Date: Oct. 31, 2019

(54) Automatic Explanation Generation for Linearly-Constrained Optimization Problems

(71) Applicant: Conversant LLC, Chicago, IL (US)

(72) Inventors: Lin Zhang, Palatine, IL (US); Michael North, Chicago, IL (US); Steven Nowlan, Chicago, IL (US)

(73) Assignee: Conversant LLC, Chicago, IL (US)

(21) Appl. No.: 16/399,427

(22) Filed: Apr. 30, 2019

Related U.S. Application Data
(60) Provisional application No. 62/664,380, filed on Apr. 30, 2018.

(51) Int. Cl. G06Q 30/02; G06F 17/11; G06F 3/0484; G06F 3/0481

(52) U.S. Cl. CPC G06Q 30/0244; G06F 3/04812; G06F 3/0484; G06F 17/11

(57) ABSTRACT

A method for generating text explanations for the results of linearly constrained optimizations of a linear program includes determining, based on one or more constraints, bounds, and variable values of the linear program, if optimization based on the one or more constraints is feasible. The method further includes if optimization based on the one or more constraints is feasible, analyzing, the one or more constraints, bounds, and variable values of the linear program, in relation to one another, to determine one or more pairs of solutions to the linear program and associated shadow prices. The method further includes determining textual explanations for each of the pairs of solutions to the linear program and the associated shadow prices and presenting, via an output display, the user with at least one of the textual explanations for each of the pairs of solutions to the linear program and the associated shadow prices.

### TECHNICAL FIELD

The present disclosure relates generally to linearly-constrained optimization programs and, more particularly, to systems for automatically generating plain, natural language explanations for linearly-constrained program results.

### BACKGROUND

Linearly-constrained optimization problems are widely used to find the best solutions for maximization or minimization problems. Linearly-constrained optimization problems consist of linear programs and optimization programs with non-linear objective functions and linear constraints. Examples include finding the most effective way to allocate a budget or to schedule production. Current linearly-constrained optimization problems produce a set of numbers that define the best solution.

One barrier to the use of linearly-constrained optimization problems is understanding the reasoning behind their numerical outputs. Large numbers of linearly-constrained programming problems are solved every day in many organizations. The results are used by people with many different levels of understanding of how linearly-constrained optimization problems work. These users often have questions about why a given linearly-constrained program produced a specific result. Answering these questions requires immense amounts of manual support work to investigate and provide explanations for the results in question.

Accordingly, this barrier to the use of such data is undesirable. Therefore, systems and methods, in which explanations for the reasoning behind the numerical outputs of such linearly-constrained optimizations can be automatically generated in plain language, are desired.

### SUMMARY

In accordance with an embodiment, a method for generating text explanations for the results of linearly constrained optimizations of a linear program is disclosed. The linear program is utilized by a user to aid in optimizing a task. The method includes determining, based on one or more constraints, bounds, and variable values of the linear program, if optimization based on the one or more constraints is feasible. The method further includes if optimization based on the one or more constraints is feasible, analyzing, using a computing device, the one or more constraints, bounds, and variable values of the linear program, in relation to one another, to determine one or more pairs of solutions to the linear program and associated shadow prices. The method further includes determining, using the computing device, textual explanations for each of the pairs of solutions to the linear program and the associated shadow prices and presenting, via a graphical user interface on an output display associated with the computing device, the user with at least one of the textual explanations for each of the pairs of solutions to the linear program and the associated shadow prices.

In accordance with another embodiment, a non-transitory, machine-readable medium, storing instructions for generating text explanations for the results of linearly constrained optimizations of a linear program, the linear program being utilized by a user to aid in optimizing a task. When the instructions are executed, they cause a machine to determine, based on one or more constraints, bounds, and variable values of the linear program, if optimization based on the one or more constraints is feasible and analyze the one or more constraints, bounds, and variable values of the linear program, in relation to one another, to determine one or more pairs of solutions to the linear program and associated shadow prices, if optimization based on the one or more constraints is feasible. When the instructions are executed, they further cause the machine to determine textual explanations for each of the pairs of solutions to the linear program and the associated shadow prices and present, via a graphical user interface on an output display associated with the machine, the user with at least one of the textual explanations for each of the pairs of solutions to the linear program and the associated shadow prices.

In accordance with yet another embodiment, a method for optimizing performance for an advertising campaign using budget allocating via linearly constrained optimizations of a linear program, the linear program being utilized by a user to aid in optimizing the advertising campaign, is disclosed. The method includes determining, based on one or more constraints, bounds, and variable values of the linear program, if optimization based on the one or more constraints is feasible. The method further includes if optimization based on the one or more constraints is feasible, analyzing, using a computing device, the one or more constraints, bounds, and variable values of the linear program, in relation to one another, to determine one or more pairs of solutions to the linear program and associated shadow prices. The method further includes determining, using the computing device, textual explanations for each of the pairs of solutions to the linear program and the associated shadow prices and presenting, via a graphical user interface on an output display associated with the computing device, the user with at least one of the textual explanations for each of the pairs of solutions to the linear program and the associated shadow prices.

### BRIEF DESCRIPTION OF THE DRAWINGS

FIG. 1 is an example plot of a linearly constrained program, for exemplary purposes of illustrating an unbounded solution region.

FIG. 2 is an exemplary flow chart for a method for generating text explanations for the results of linearly constrained optimizations of a linear program, in accordance with an embodiment of the disclosure.

FIG. 3 is an exemplary flow chart further detailing a selection of steps of the method and flowchart of FIG. 2, in accordance with FIG. 2 and its associated embodiment of the disclosure.

FIG. 4 is an exemplary flow chart further detailing a selection of steps of the method and flowchart of FIG. 2, in accordance with FIG. 2 and its associated embodiment of the disclosure.

FIG. 5 is an exemplary flow chart further detailing a selection of steps of the method and flowchart of FIG. 4, in accordance with FIG. 2, FIG. 4, and their associated embodiment of the disclosure.

FIG. 6 is an illustration of an exemplary display showing text explanations for results of linearly constrained optimizations of a linear program, as generated, for example, by the method of FIGS. 2-5, in accordance with an embodiment of the disclosure.

FIG. 7 is an illustration of an alternative exemplary display showing text explanations for results of linearly constrained optimizations of a linear program, as generated, for example, by the method of FIGS. 2-5, in accordance with an embodiment of the disclosure.

FIG. 8 is an illustration of another alternative exemplary display showing text explanations for results of linearly constrained optimizations of a linear program, as generated, for example, by the method of FIGS. 2-5, in accordance with an embodiment of the disclosure.

FIG. 9 is an illustration of another alternative exemplary display showing text explanations for results of linearly constrained optimizations of a linear program, as generated, for example, by the method of FIGS. 2-5, in accordance with an embodiment of the disclosure.

FIG. 10 is a block diagram of an exemplary computing device capable of embodying one or more elements of FIGS. 1-9.

While the present disclosure is susceptible to various modifications and alternative constructions, certain illustrative examples thereof will be shown and described below in detail. The disclosure is not limited to the specific examples disclosed, but instead includes all modifications, alternative constructions, and equivalents thereof.

### DETAILED DESCRIPTION

The following discloses how to automatically generate plain, natural language (e.g., English) explanations for linearly-constrained program results. These explanations output by the systems and methods, disclosed below, provide the reasoning behind the numerical outputs which make it easier for users to accept and implement the recommendations from the optimizer.

Linearly-constrained optimization problems consist of linear programs and optimization programs with non-linear objective functions and linear constraints. Furthermore, the systems and methods, disclosed herein, will make recommendations on how to improve the results of future linearly-constrained program runs.

Large numbers of linearly-constrained programming problems are solved every day in many organizations. The results may be used by people with many different levels of understanding of how linearly-constrained optimization problems work. These users often have questions about why a given linearly-constrained program produced a specific result. Answering these questions requires immense amounts of manual support work to investigate and provide explanations for the results in question. The automatically generated explanations, disclosed herein, will significantly reduce the amount of support time developers of linearly-constrained optimization problems need to spend manually explaining the results of their creations as well as increase the likelihood that users will adopt the recommendations of linearly-constrained optimization problems.

When a linearly-constrained program runs through a solver and processed by a machine, such as a computing device, there will be two outcomes, success or failure. A failure means infeasibility or in other words, an optimal solution can't be found by the solver satisfying the given constraints for the objective function(s). In case of failures, explanations will be provided about the cause of the infeasibility. A success means an optimal solution is found satisfying the given constraints. In this case an explanation will be provided as to why the result is optimal.

There are several major causes of infeasibility in linearly-constrained optimization problems. These causes are contradictory constraints and unboundedness.

Contradictory constraints can be identified and possibly corrected using the irreducible infeasible sets (IIS) approach. An irreducible infeasible set is a minimal set of constraints and variable bounds which is infeasible but becomes feasible if any constraint or bound in it is removed. For example, the constraint 0≤x+y≤5 contradicts the constraint 6≤x+y≤7. Neither constraint can by replaced by the other, but if you remove one of them, the feasible region is not empty anymore. The method of irreducible infeasible sets works by identifying the irreducible infeasible sets first and then suggest which constraint to be removed. With the systems and methods described below, based on the problem, a natural language explanation will be provided as to which constraints are in conflict and a remedying recommendation will be provided as to which constraints might be removed.

Unboundedness means the objective function may be improved indefinitely without violating the constraints and bounds. This usually happens if a problem is being solved with the wrong optimization sense (e.g., a maximization problem is being minimized). This means that the decision variables that are not limited from above for maximization and or from below for minimization.

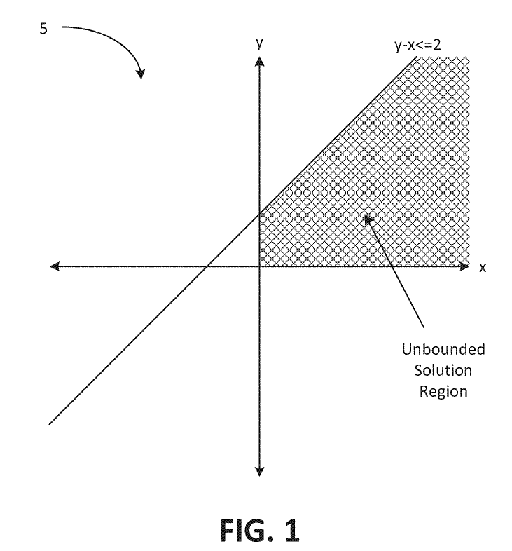

For example, it may be desired to maximize 3x+2y, subject to x≥0 and y≥0 and y−x≤2; a plot of this example is illustrated in FIG. 1. The solution region is in the first quadrant below the line y−x≤2. This region is not bounded. As x or y increases, 3x+2y will increase unboundedly. In this case, we are solving the wrong problem, instead of maximizing, we should be minimizing 3x+2y.

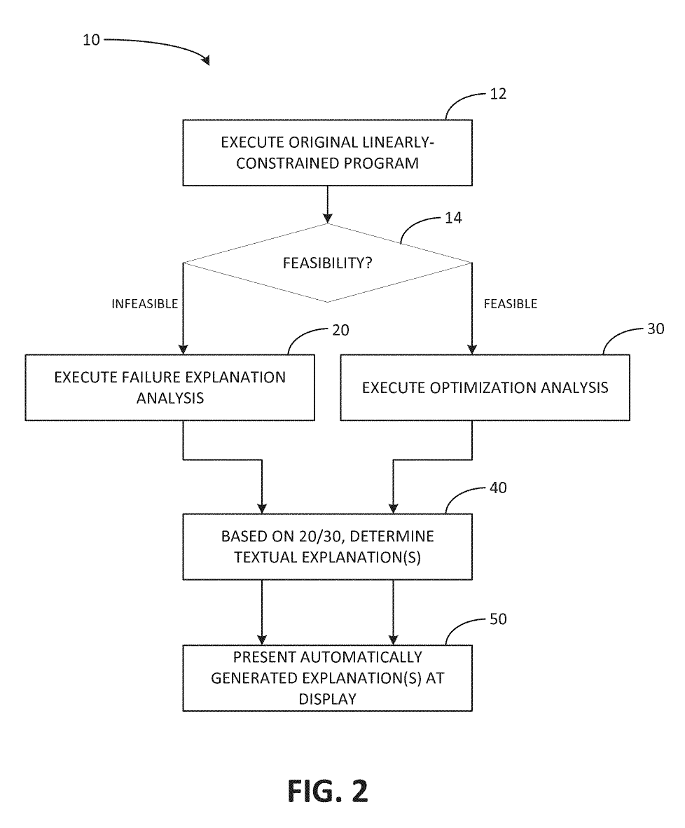

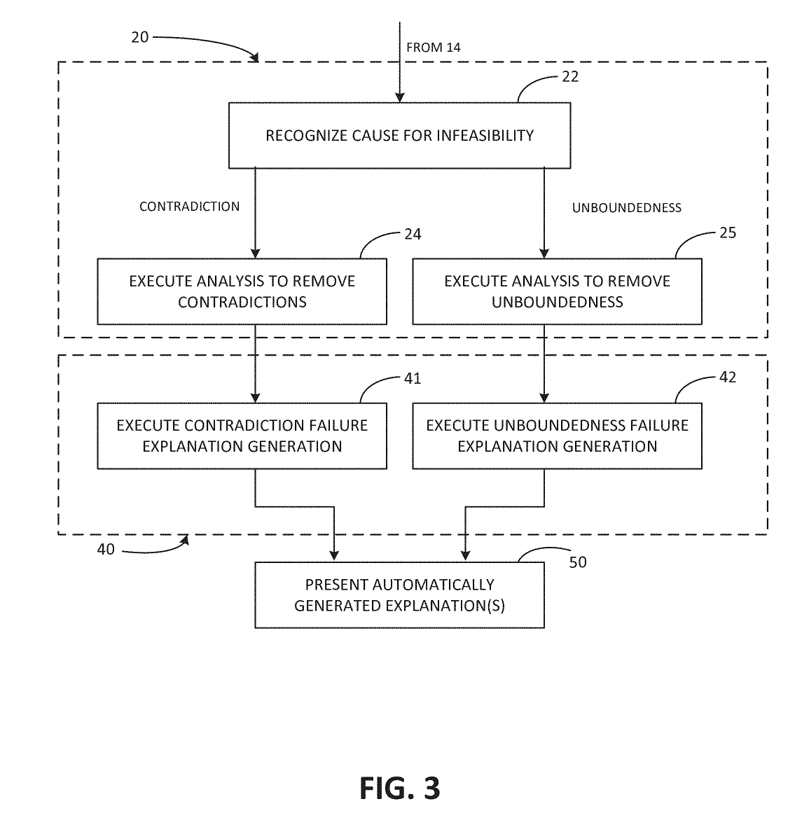

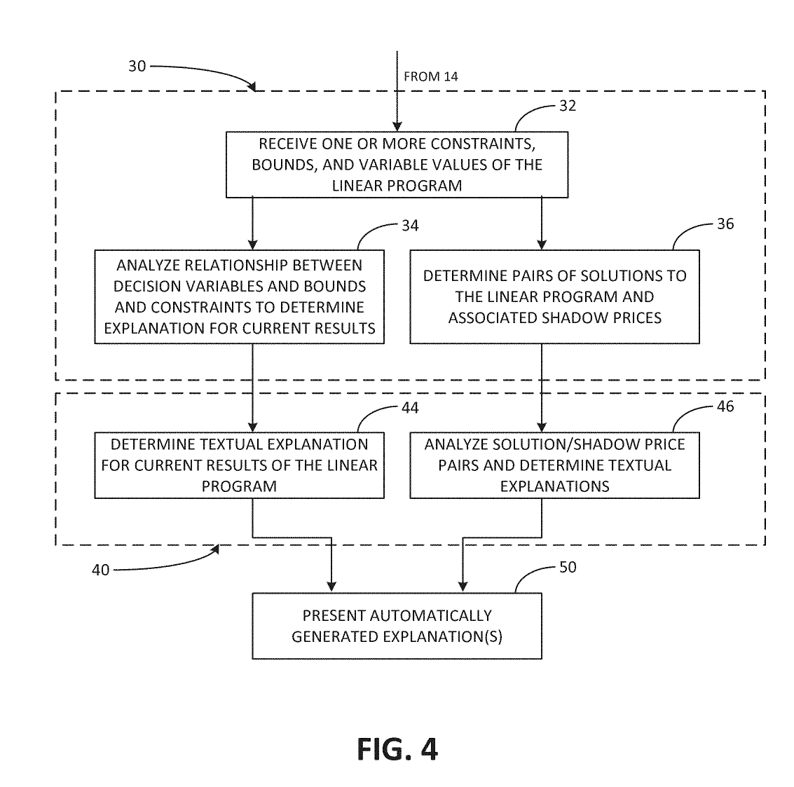

Turning now to FIG. 2, a flowchart for a method 10 for generating text explanations for the results of linearly constrained optimizations of a linear program is illustrated. The linear program may be being utilized by a user to aid in optimizing a task. Such tasks may include, but are not limited to including, advertising operations, such as optimizing return on ad spend. Beginning at block 12, the method begins by formulating the task by executing the linearly-constrained program and then, at decision 14, determining if the task is feasible or infeasible via, for example, pre-solving and solving. Such a determination is based on, at least, constraints, bounds, and variable values of the linear program. If it is determined that the linearly constrained program is feasible under the constraints, bounds, and variables of the linear program, in relation to one another, then the method continues to block 30, wherein optimization analysis then occurs. The actions at block 30 are discussed below, in greater detail, with reference to FIG. 4. Otherwise, if it is determined that the linearly-constrained program is infeasible, then the method 10 proceeds to block 20, wherein failure explanation analysis is executed to determine cause of infeasibility. A greater explanation of the actions at block 20 are discussed, in greater detail, below, with reference to FIG. 3.

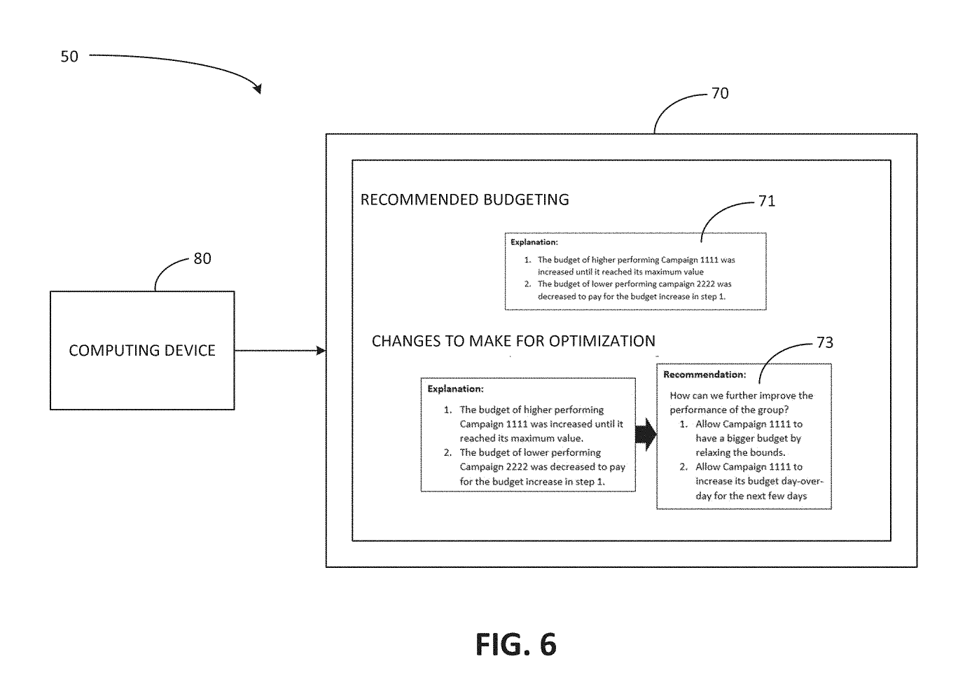

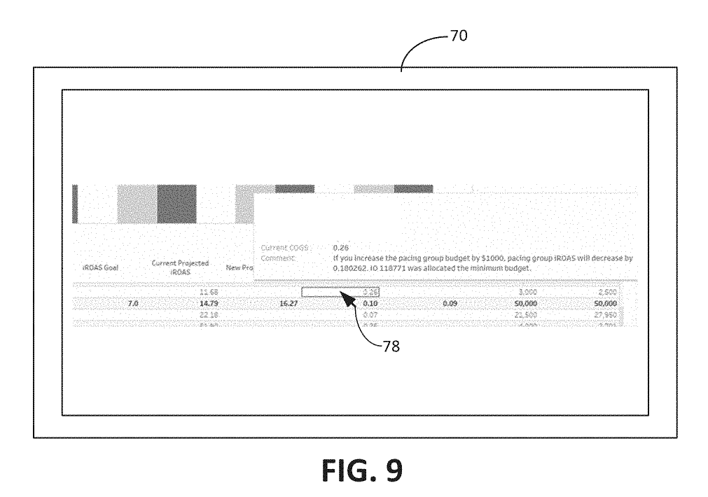

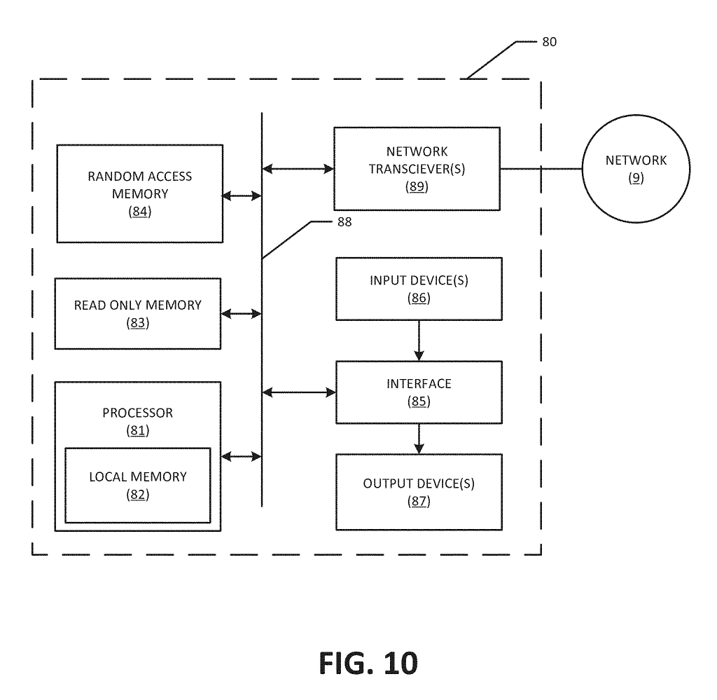

With the analysis of block 20 and/or block 30 executed, the method 10 then continues to block 40, wherein textual explanations for the analysis of blocks 20, 30 are generated. Greater details of generation of said textual explanations are described in greater detail, below, as they relate to blocks 20, 30, in FIGS. 3 and 4, respectively. With the textual explanations generated, the method then continues to block 50, wherein the user is presented with at least one textual explanation for a failure analysis or an optimization analysis. Such presentation is performed via a display (e.g., a display 70 of FIGS. 6-9) associated with a computing device (e.g., a computing device 80 of FIGS. 6 and 10) that executes the method 10. Accordingly, the method 10 may be performed as instructions on a non-tangible, machine readable medium associated with the computing device 80 which, when executed, cause the computing device 80 to perform the method 10.

Turning now to FIG. 3, with continued reference to FIG. 2, if the linear program with the original constraints, bounds, and variable values is determined to be infeasible, the method 10 will determine if the cause of infeasibility is a contradiction (e.g., contradictory constraints) or unboundedness. Contradiction and unboundedness, as they relate to issues of linearly constrained optimizations of linear programs, are defined and discussed in detail, above. If the failure is due to a contradiction, then, at block 24, an analysis is performed to determine constraints to remove which will eliminate the contradiction. Alternatively, at block 25, if the problem is found to be unboundedness, then analysis is performed to determine how (e.g., a reversal of maximizing versus minimizing) to remove the unboundedness.

In the infeasible scenarios of FIG. 2, it means that at block 40, the method 10 automatically generates failure textual information associated with the cause of infeasibility, wherein the failure textual information includes, at least, a textual indication of the cause of infeasibility. Accordingly, in such examples generating failure textual information further includes generating a recommendation of constraints, bounds, and variable values of the linear program to remove to make the optimization feasible. In the example of contradiction, as exemplified by block 41, generating failure textual information may include contradiction failure explanation generation, which includes determining one or more constraints to remove that would eliminate the contradiction. In the example of unboundedness, as exemplified by block 42, generating failure textual information may include unboundedness failure explanation generation, which may include instructions for removing the unboundedness issue and/or alerts to the unboundedness issue. In either scenario, the method 10 will continue to block 50, wherein the textual information generated at block 40 is presented to the user.

Returning to the outcome of the initial inquiry at decision 14, in examples in which the linearly constrained optimization is feasible and the method 10 continues to block 20, operations for such an optimization analysis are further illustrated in FIG. 4. Accordingly, at block 32, the method 10 receives the one or more constraints, bounds, and variable values of the linear program for use in the optimization analysis. In some examples, the optimization analysis of block 30 includes block 34, in which the relationships between decision variables, bounds, and constraints are analyzed to determine an explanation for the current results of the linear program. In such examples, block 40 may implement block 44 which determines textual explanations for the current results (e.g., optimal answer) for the linear program.

In addition to or as an alternative to block 34, the analysis of block 30 may include block 36, in which the one or more constraints, bounds, and variable values of the linear program are used to determine one or more pairs of solutions to the linear program and associated shadow prices. In linearly-constrained programming problems, the shadow price of a constraint is the difference between the optimal value of the of the objective function and the value of the objective function, evaluated at the optional basis, when the right-hand side of a constraint is increased by one unit. In other words, a shadow price is an optimal solution value for a bound, constraint, or variable, which is repeatedly increased by one to evaluate what affect that has on the optimization of the linear program. Paired with a solution value, this data can be utilized to optimize bounds and constraints by changing them or altering variables.

In such examples, the analysis of block 36 is used in the process of block 40 to determine textual explanations for each of the pairs of solutions to the linear program and associated shadow prices. In some examples, this may include determining alterations to one or more of the constraints, bounds, and variable values that would further optimize the linear program. With the determinations of block 46 completed, at block 50, the user is presented with at least one of the textual explanations for each of the pairs of solutions to the linear program and the associated shadow prices. In some examples, this includes automatically generating alteration textual information, for presentation to the user, detailing the alterations to one or more of the constraints, bounds, and variable values that would further optimize the linear program.

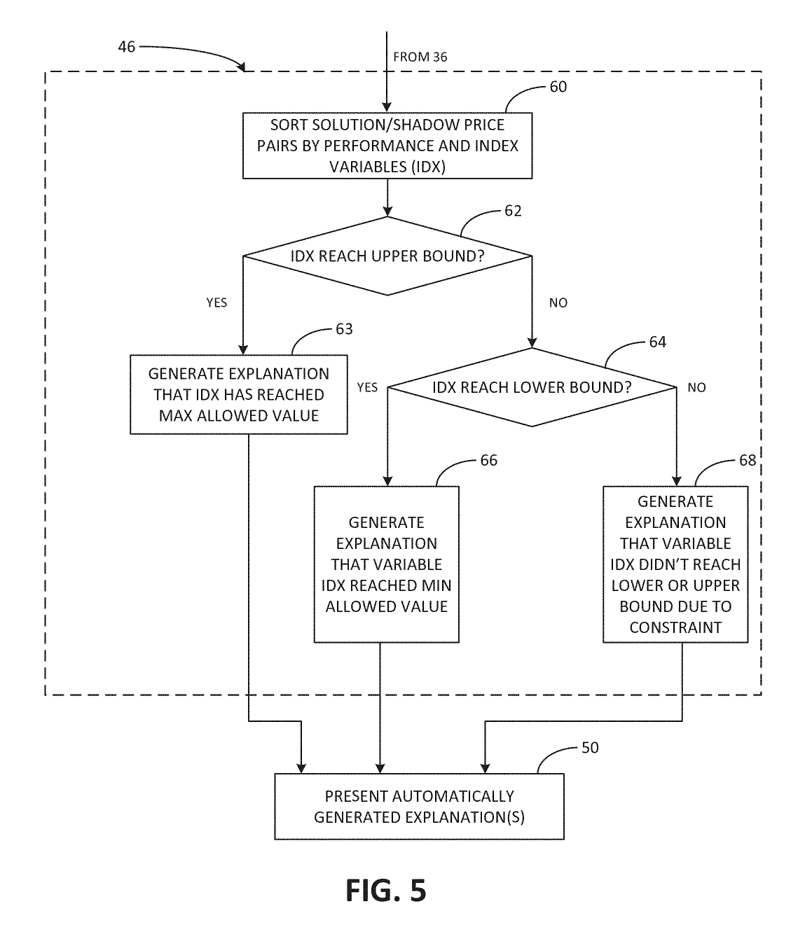

In some examples, such as an example implementation of the analysis of block 46 shown in FIG. 5. At block 60, the solution and shadow price pairs are indexed by variables by performance standards selected by the user. At decision 62, it is determined if the index reaches an upper bound, if it does an explanation is generated that the index variables have a max allowed value (block 63). If, at 62, it is determined that the upper bound is not reached, then it is determined if a lower bound is reached at decision 64. If it is determined that the variable reaches a lower bound, then an explanation is generated that the index variable reached a minimum allowed value (block 66); otherwise, at block 68, generate an explanation that variable index did not reach a lower or upper bound due to a constraint.

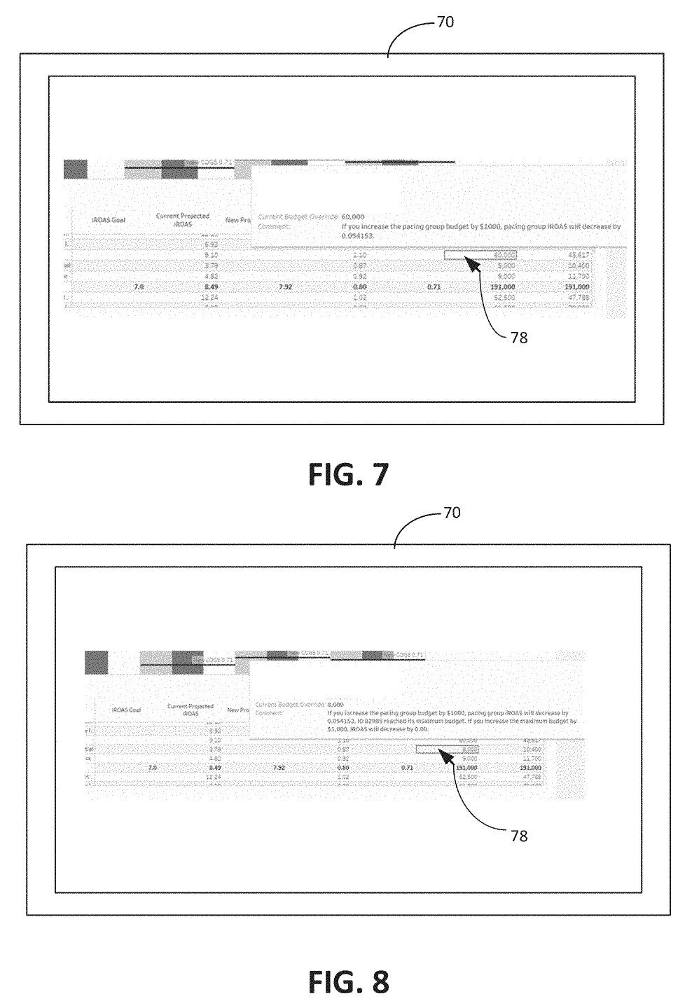

Turning now to FIG. 6, but with continued reference to FIGS. 2-5, the implementation of the execution of block 50 is shown, wherein the computing device 80 causes the display 70 to display textual information derived from the results of linearly-constrained optimization of a linear program. Additionally, FIGS. 7-9 illustrate examples of presentations of textual information derived from the results of the linearly-constrained optimization of a linear program. Particularly, FIGS. 7-9 show examples in which it is the analysis at block 20 determines alterations to one or more of the constraints bounds and variable values that would further optimize the linear program and, wherein at block 40 textual information is automatically generated, for presentation to the user, detailing the alterations to one or more constraints, bounds and variable values that would further optimize the linear program.

Another feature of the display examples of FIGS. 7-9 is that pairs of shadow prices and solutions to the linear program are shown to the user via the graphical user interface. While we refer to “pairs” of shadow prices, it is contemplated that each solution is not exclusive to a particular shadow price and can be used with multiple shadow prices, as individual shadow prices for any bounds, constraints, and variables may be used in this method. Further, when displaying the shadow price versus solution data as shown, at least one textual explanation for a pair of solutions to the linear program and associated shadow prices can be displayed in response to user input via an input device associated with the computing device (e.g., in response to a mouse causing a cursor 78 to hover over a piece of data, as shown).

For the purposes of example, we can imagine a merely exemplary example of implementation of the method 100, in the context of advertising budget allocation for a client of the user's ad campaign. Consider an example of a linearly-constrained program, in this case a linear program, for online advertising. Linearly-constrained optimization problems have two major components: a linear objective function to maximize or minimize and linear equality or inequality constraints, as shown below,

maximize c^{T}X

subject to AX≤b

X≥0

X represents the decision variables in the form of X=(x₁, x₂, . . . , xₙ), c and b are constant vectors with n and m elements. A is an m×n coefficient matrix. Please note that if one constraint is “≥,” we can multiply by −1 to make it “≤.” If one constraint is “=,” we can add a small number to make it “≤.”

In this example, the task is optimizing an impact score of the advertising. Consider the user, Company C, runs advertising campaigns for Company S. At the moment, company S is running two campaigns: Campaign 1111 and Campaign 2222. Campaign 1111 is assigned an initial budget of $5,000, and Campaign 2222 is assigned an initial budget of $15,000. The total budget is $20,000. Company S gives Company C some flexibility on how to allocate the total budget of $20,000 to the two campaigns as long as it doesn't overspend. In other words, the total budget is not exceeded. Success is measured using impact scores. Campaign 1111 has an impact score of 20. Campaign 2222 has an impact score of 12. Company S is focused on the total impact score of the two campaigns combined. The initial budget-weighted impact score is (20*5000+12*15000)/20000=14. The goal for Company C is to improve the group's performance. The business enforces the following rules (bounds and constraints):
a) No adjustment over 50% is allowed. In other words, Campaign 1111 can only have a budget between $2,500 and $7,500. Campaign 2222 can only have budget between $7,500 and $22,500.
b) The total budget equals $20,000.
c) The group's performance is measured by the average of the two campaigns' performance weighted by the budgets.

Formulation: There are two decision variables, the budget for Campaign 1111 and budget for Campaign 2222. Let:
B1 be the budget for Campaign 1111, and
B2 be the budget for Campaign 2222.

The constraints are then:
2500≤B1≤7500 (i.e., no more than 50% adjustment per business requirement, the lower bound and upper bound of B1)
7500≤B2≤22500 (i.e., no more than 50% adjustment constraint per business requirement, the lower bound and upper bound of B2)
B1+B2=20000 (i.e., the total budget constraint)
   Since this is an equation, we can add a small number ε to make it the following B1+B2−ε≤20000
   0≤ε≤0.1 (i.e., this small number is used to convert equalities into inequalities since inequalities are easier to work with) (Note that many linearly-constrained program solvers handle this internally without the modelers explicitly spelling it out).

The objective function is:

Maximize (20*B1+12*B2)/20000 (i.e., maximize the weighted average of the performance for the group)

Therefore, based on the constraints and bounds detailed above, the method 10 at block 14 can determine that the function is feasible, so it moves to block 30 for optimization analysis, as detailed below:

Solution: It is easy to see the current performance of the group is

$$\frac{5000 * 20 + 15000 * 12}{20000} = 14.$$

Any linearly-constrained program solver can easily solve the problem and get the optimal solution of B1=7500 and B2=12500 and the objective function value of (20*7500+12*12500)/20000=15. This is an improvement over the current value of 14.

Having executed the optimization analysis at block 30, then the method 10 continues to determining textual explanations for the optimization analysis and then presents the automatically generated explanations at the display 70, executing block 50.

Explanation 71 for display to the user (See the exemplary display of FIG. 6, showing the end result of this example):
1. The budget of higher performing Campaign 1111 was increased until it reached its maximum value
2. The budget of lower performing campaign 2222 was decreased to pay for the budget increase in step 1.

In examples where it is desired to obtain advisement for changes to obtain better optimization, the explanations displayed may include the recommendations 73.

The method 10 generates natural language (e.g., English or any other human language) explanations specifically for linearly-constrained optimization problems. Without the method 10, linearly-constrained optimization problems only produce numeric outputs and linearly-constrained program users must manually determine why a given solution was produced.

FIG. 10 is a block diagram of an example computer 80 capable of executing instructions to realize the functions of the method 10 of FIGS. 2-9. The computer 80 may be, for example, a server, a personal computer, or any other type of computing device. The computer 80 of the instant example includes a processor 81. For example, the processor 81 may be implemented by one or more microprocessors or controllers from any desired family or manufacturer.

The processor 81 includes a local memory 82 and is in communication with a main memory including a read only memory 83 and a random-access memory 84 via a bus 88. The random-access memory 84 may be implemented by Synchronous Dynamic Random Access Memory (SDRAM), Dynamic Random Access Memory (DRAM), RAMBUS Dynamic Random Access Memory (RDRAM) and/or any other type of random access memory device. The read only memory 83 may be implemented by a hard drive, flash memory and/or any other desired type of memory device.

The computer 80 may also include an interface circuit 85. The interface circuit 85 may be implemented by any type of interface standard, such as, for example, an Ethernet interface, a universal serial bus (USB), and/or a PCI express interface. One or more input devices 86 are connected to the interface circuit 85. The input device(s) 86 permit a user to enter data and commands into the processor 81. The input device(s) 86 can be implemented by, for example, a keyboard, a mouse, a touchscreen, a track-pad, a trackball, and/or a voice recognition system. For example, the input device(s) 86 may include any wired or wireless device for connecting the computer 80 to the positioning system 88 to receive positioning signals.

One or more output devices 87 are also connected to the interface circuit 85. The output devices 87 can be implemented by, for example, display devices for associated data (e.g., a liquid crystal display, a cathode ray tube display (CRT), etc.). The display 70 may be one such display devices and, contextually, may be considered an output device 87 of the computer 80

Further, the computer 80 may include one or more network transceivers 89 for connecting to a network, such as the Internet, a WLAN, a LAN, a personal network, or any other network for connecting the computer 80 to one or more other computers or network capable devices.

As mentioned above the computer 80 may be used to execute machine readable instructions. For example, the computer 80 may execute machine readable instructions to perform the methods shown in the block diagrams of FIGS. 2-5. In such examples, the machine-readable instructions comprise a program for execution by a processor such as the processor 81 shown in the example computer 80. The program may be embodied in software stored on a tangible computer readable medium such as a CD-ROM, a floppy disk, a hard drive, a digital versatile disk (DVD), a Blu-ray disk, or a memory associated with the processor 81, but the entire program and/or parts thereof could alternatively be executed by a device other than the processor 81 and/or embodied in firmware or dedicated hardware. Further, although the example programs are described with reference to systems and methods above, many other methods of implementing embodiments of the present disclosure may alternatively be used. For example, the order of execution of the blocks may be changed, and/or some of the blocks described may be changed, eliminated, or combined.

1. A method for generating text explanations for the results of linearly constrained optimizations of a linear program, the linear program being utilized by a user to aid in optimizing a task, the method comprising:
determining, based on one or more constraints, bounds, and variable values of the linear program, if optimization based on the one or more constraints is feasible;
if optimization based on the one or more constraints is feasible, analyzing, using a computing device, the one or more constraints, bounds, and variable values of the linear program, in relation to one another, to determine one or more pairs of solutions to the linear program and associated shadow prices;
determining, using the computing device, textual explanations for each of the pairs of solutions to the linear program and the associated shadow prices; and
presenting, via a graphical user interface on an output display associated with the computing device, the user with at least one of the textual explanations for each of the pairs of solutions to the linear program and the associated shadow prices.

2. The method of claim 1, further comprising, if optimization based on the one or more constraints, bounds, and variable values of the linear program is infeasible, determining the cause of infeasibility based on the one or more constraints, bounds, and variable values of the linear program; and
automatically generating failure textual information associated with the cause of infeasibility, the failure textual information including, at least, a textual indication of the cause of infeasibility.

3. The method of claim 2, wherein generating failure textual information further includes generating a recommendation of constraints, bounds, and variable values of the linear program to remove to make the optimization feasible.

4. The method of claim 1, wherein the cause of infeasibility may include one or both of a contradiction within the one or more constraints of the linear program and an unboundedness of one or more of the constraints of the linear program.

5. The method of claim 1, further comprising determining, using the computing device, alterations to one or more of the constraints, bounds, and variable values that would further optimize the linear program; and
automatically generating alteration textual information, for presentation to the user, detailing the alterations to one or more of the constraints, bounds, and variable values that would further optimize the linear program.

6. The method of claim 1, further comprising presenting, to the user via the graphical user interface on the display associated with the computing device, the pairs of solutions to the linear program and associated shadow prices; and
displaying, to the user via the graphical user interface on the display associated with the computing device, one of the textual explanations for each of the pairs of solutions to the linear program and the associated shadow prices in response to user input via an input device associated with the computing device.

7. The method of claim 6, wherein the user input via the input device causes a cursor within the graphical user interface to move, and
wherein displaying one of the textual explanations for each of the pairs of solutions to the linear program and the associated shadow prices includes, when the cursor is proximate to or overlapping one of the pairs of solutions to the linear program and associated shadow prices, displaying the textual explanation associated with the pair of solutions and to the linear program and the associated shadow price with which the cursor is proximate to or overlapping.

8. A non-transitory, machine-readable medium, storing instructions for generating text explanations for the results of linearly constrained optimizations of a linear program, the linear program being utilized by a user to aid in optimizing a task, which, when the instructions are executed, cause a machine to:
determine, based on one or more constraints, bounds, and variable values of the linear program, if optimization based on the one or more constraints is feasible;
analyze the one or more constraints, bounds, and variable values of the linear program, in relation to one another, to determine one or more pairs of solutions to the linear program and associated shadow prices, if optimization based on the one or more constraints is feasible;
determine textual explanations for each of the pairs of solutions to the linear program and the associated shadow prices; and
present, via a graphical user interface on an output display associated with the machine, the user with at least one of the textual explanations for each of the pairs of solutions to the linear program and the associated shadow prices.

9. The non-transitory, machine-readable medium of claim 8, wherein, when executed, the instructions further cause the machine to determine the cause of infeasibility based on the one or more constraints, bounds, and variable values of the linear program, if optimization based on the one or more constraints, bounds, and variable values of the linear program is infeasible; and
automatically generate failure textual information associated with the cause of infeasibility, the failure textual information including, at least, a textual indication of the cause of infeasibility.

10. The non-transitory, machine-readable medium of claim 9, wherein generating failure textual information further includes generating a recommendation of constraints, bounds, and variable values of the linear program to remove to make the optimization feasible.

11. The non-transitory, machine-readable medium of claim 8, wherein the cause of infeasibility may include one or both of a contradiction within the one or more constraints of the linear program and an unboundedness of one or more of the constraints of the linear program.

12. The non-transitory, machine-readable medium of claim 8, wherein, when executed, the instructions further cause the machine to determine alterations to one or more of the constraints, bounds, and variable values that would further optimize the linear program; and
automatically generate alteration textual information, for presentation to the user, detailing the alterations to one or more of the constraints, bounds, and variable values that would further optimize the linear program.

13. The non-transitory, machine-readable medium of claim 8, wherein, when executed, the instructions further cause the machine to present, to the user via the graphical user interface on the display associated with the machine, the pairs of solutions to the linear program and associated shadow prices; and
display, to the user via the graphical user interface on the display associated with the machine, one of the textual explanations for each of the pairs of solutions to the linear program and the associated shadow prices in response to user input via an input device associated with the computing device.

14. The non-transitory, machine-readable medium of claim 13, wherein the user input via the input device causes a cursor within the graphical user interface to move, and
wherein displaying one of the textual explanations for each of the pairs of solutions to the linear program and the associated shadow prices includes, when the cursor is proximate to or overlapping one of the pairs of solutions to the linear program and associated shadow prices, displaying the textual explanation associated with the pair of solutions and to the linear program and the associated shadow price with which the cursor is proximate to or overlapping.

15. A method for optimizing performance for an advertising campaign using budget allocation via linearly constrained optimizations of a linear program, the linear program being utilized by a user to aid in optimizing the advertising campaign, the method comprising:
determining, based on one or more constraints, bounds, and variable values of the linear program, if optimization based on the one or more constraints is feasible;
if optimization based on the one or more constraints is feasible, analyzing, using a computing device, the one or more constraints, bounds, and variable values of the linear program, in relation to one another, to determine one or more pairs of solutions to the linear program and associated shadow prices;
determining, using the computing device, textual explanations for each of the pairs of solutions to the linear program and the associated shadow prices; and
presenting, via a graphical user interface on an output display associated with the computing device, the user with at least one of the textual explanations for each of the pairs of solutions to the linear program and the associated shadow prices.

16. The method of claim 15, further comprising, if optimization based on the one or more constraints, bounds, and variable values of the linear program is infeasible, determining the cause of infeasibility based on the one or more constraints, bounds, and variable values of the linear program; and
automatically generating failure textual information associated with the cause of infeasibility, the failure textual information including, at least, a textual indication of the cause of infeasibility.

17. The method of claim 16, wherein generating failure textual information further includes generating a recommendation of constraints, bounds, and variable values of the linear program to remove to make the optimization feasible.

18. The method of claim 15, further comprising determining, using the computing device, alterations to one or more of the constraints, bounds, and variable values that would further optimize the linear program; and
automatically generating alteration textual information, for presentation to the user, detailing the alterations to one or more of the constraints, bounds, and variable values that would further optimize the linear program.

19. The method of claim 15, further comprising presenting, to the user via the graphical user interface on the display associated with the computing device, the pairs of solutions to the linear program and associated shadow prices; and
displaying, to the user via the graphical user interface on the display associated with the computing device, one of the textual explanations for each of the pairs of solutions to the linear program and the associated shadow prices in response to user input via an input device associated with the computing device.

20. The method of claim 19, wherein the user input via the input device causes a cursor within the graphical user interface to move, and
wherein displaying one of the textual explanations for each of the pairs of solutions to the linear program and the associated shadow prices includes, when the cursor is proximate to or overlapping one of the pairs of solutions to the linear program and associated shadow prices, displaying the textual explanation associated with the pair of solutions and to the linear program and the associated shadow price with which the cursor is proximate to or overlapping.
